(19) United States
(12) Patent Application Publication
(10) Pub. No.: US 2025/0345963 A1
(43) Pub. Date: Nov. 13, 2025

(54) PERFORATING UNIT FOR WEBLIKE MATERIALS

(71) Applicant: FUTURA S.P.A., Capannori (IT)

(72) Inventors: Gabriele BETTI, Capannori (IT); Manolo TAMAGNINI, Porcari (IT)

(73) Assignee: FUTURA S.P.A., Capannori, LU (IT)

(21) Appl. No.: 18/871,884

(22) PCT Filed: Jul. 14, 2023
(86) PCT No.: PCT/IT2023/050163

§ 371 Date: Dec. 5, 2024

(30) Foreign Application Priority Data
Jul. 25, 2022 (IT) 102022000015537

(51) Int. Cl. B26F 1/20

(52) U.S. Cl. CPC B26F 1/20

(57) ABSTRACT

A perforating unit for forming perforation lines on web-like materials, in which the perforation lines are formed by a predetermined number of perforations spaced apart by a predetermined value and aligned along a preset direction of perforation; the perforating unit includes an optical unit able to optically detect the perforations and configured to acquire images of the web material in correspondence with the perforation lines and connected to a programmable processing unit which receives electric signals produced by the optical unit for emitting an error signal indicative of an anomaly condition relating to the operation of the perforating group according to the comparison between the number of detected perforations and the predetermined number of perforations.

### FIELD

The present invention relates to a perforating unit for weblike materials with a perforation control system.

In particular, although not exclusively, a system for controlling a perforating unit for weblike materials in accordance with the present invention can be used to control the perforation of the paper plies that feed the rewinding machines in paper converting processes.

### BACKGROUND

It is known that in paper converting processes a rewinder transforms the paper of a large diameter reel, generally called “parent reel”, into a plurality of smaller diameter logs which are subsequently subjected to transversal cutting to obtain rolls of predefined length such as toilet paper rolls, kitchen rolls, kitchen towels, etc. Upstream of the rewinder, a perforating unit is arranged to form transversal perforation lines on the web-like material provided by the parent reel. In this way, each roll will be formed by a succession of sheets separated by the perforation lines which facilitate the separation of the individual sheets when required. In general, a perforating unit comprises a blade-holder roller, on which several angularly equidistant blades are mounted, and a roller on which a counter-blade is mounted. In general, the blade holder roller rotates around its own axis with a predetermined angular speed while the counter blade is fixed. Perforation lines are produced by the cyclic contact of the blades with the counter blade.

Due to wear or breakage of one or more blades, or of the counter-blade, or incorrect assembly, or also due to the possible loss of reciprocal position of said rollers, the perforations may exhibit defects. For example, perforations may be fewer than required.

US2014/121085 discloses a machine provided with a perforating unit for producing perforation lines on a web material comprising an optical unit used to count the perforation lines so as to count the pages defined by the perforation lines for the maintenance of the perforating elements after the formation of a given number of pages.

### SUMMARY

The main object of the present invention is to provide a system for controlling the perforating unit suitable for automatically detecting the operating state of said unit by analyzing the perforations performed on the web material.

This result has been achieved, in accordance with the present invention, by adopting the idea of realizing a system having the features indicated in claim 1. Other features of the present invention are the subject of the dependent claims.

Thanks to the present invention, it is possible to monitor the operating status of the perforating unit through an analysis of the perforations performed on the web-like material. It is also possible to automatically adjust the reciprocal position of the blade being used and counter-blade based on the analysis of the perforations to correct the detected errors. Furthermore, a control system in accordance with the present invention has a relatively low cost compared to the advantages it offers and can also be implemented in already existing production plants.

### BRIEF DESCRIPTION OF THE DRAWINGS

These and further advantages and characteristics of the present invention will be more and better understood by any person skilled in the art thanks to the following description and the annexed drawings, provided by way of example but not to be considered in a limiting sense, in which:

FIG. 1 is a perspective view of a perforating unit which can be used, for example, to provide transversal perforations on a web of paper material for the production of paper logs;

FIG. 2 is a side view of a perforating unit which can be used, for example, to provide transversal perforations on a web of paper material for the production of paper logs;

FIG. 3 is a schematic top view of the perforating unit of FIGS. 1 and 2 in which the rollers 1 and 2 are not shown but the respective axes A1 and A2 are shown;

FIG. 4 schematically represents the passage of a web-like material through the perforating unit;

FIG. 5 schematically represents a web-like material with transversal perforation lines;

FIG. 6 schematically represents the optical control zone according to a possible embodiment;

FIG. 7 is a simplified block diagram relating to a possible implementation mode of a control system in a perforating unit in accordance with the present invention;

FIG. 8 is a schematic top view relating to a possible mode of mounting of the optical unit 3;

FIG. 9A schematically represents the passage of the web material through a control subzone;

FIG. 9B schematically represents the passage of the web material through a control subzone;

FIG. 9C schematically represents the passage of the web material through a control subzone;

FIG. 9D schematically represents the passage of the web material through a control subzone;

FIG. 10A schematically represents possible defects of the perforation lines produced by the perforator unit;

FIG. 10B schematically represents possible defects of the perforation lines produced by the perforator unit; and

FIG. 10C schematically represents possible defects of the perforation lines produced by the perforator unit.

### DETAILED DESCRIPTION OF THE EMBODIMENTS

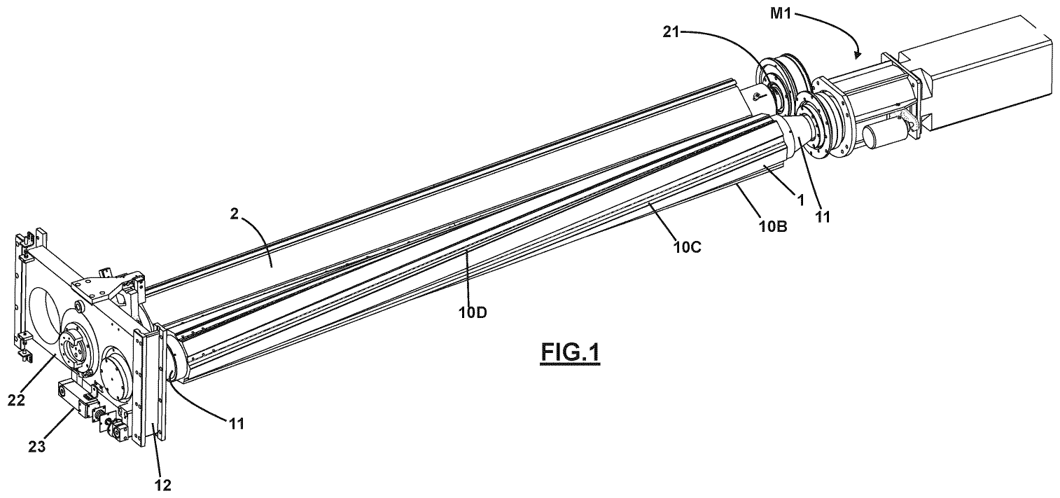

The perforating unit GP shown by way of example in FIGS. 1-3 comprises a first blade-holder roller 1 and a second roller 2 on which a plurality of counter-blades is mounted.

Several blades 10A-10F are mounted on the blade-holder roller 1 uniformly distributed on the external surface of the same blade-holder roller 1.

The blade roller 1 rotates with a predetermined angular speed around its own longitudinal axis A1 being connected to a respective electric motor M1 acting on one of its pins 11.

For example, the blades 10A-10F are six in number but it is understood that they can be in any number depending on the web material to be processed and the desired distance between the perforation lines to be produced on the web material. In general, for example, the blades could be between one and twelve in number.

In this example, the second roller 2 is stationary during the perforation of the web material. Preferably, a plurality of counter-blades 20 is mounted on the roller 2, forming a sort of magazine which avoids having to disassemble the roller 2 when a counter-blade needs to be replaced: with this configuration of the counter-roller 2, it is sufficient to rotate the latter to bring an intact counter-blade 20 in place of the worn or broken counter-blade. Preferably, the counter-blades 20 are rectilinear, mounted on the lateral surface of the roller 2 parallel to the longitudinal axis of the latter.

Preferably, the blades 10A-10F have a helical shape and the counter-blades 20 are stationary so that the contact between the blades 10A-10F and the counter-blade 20 in use is substantially point-like and continuous over the time in order to avoid stresses which could lead to premature breakage of the blades 10A-10F.

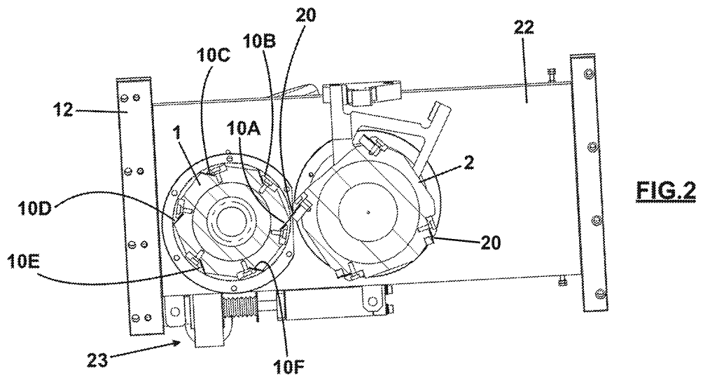

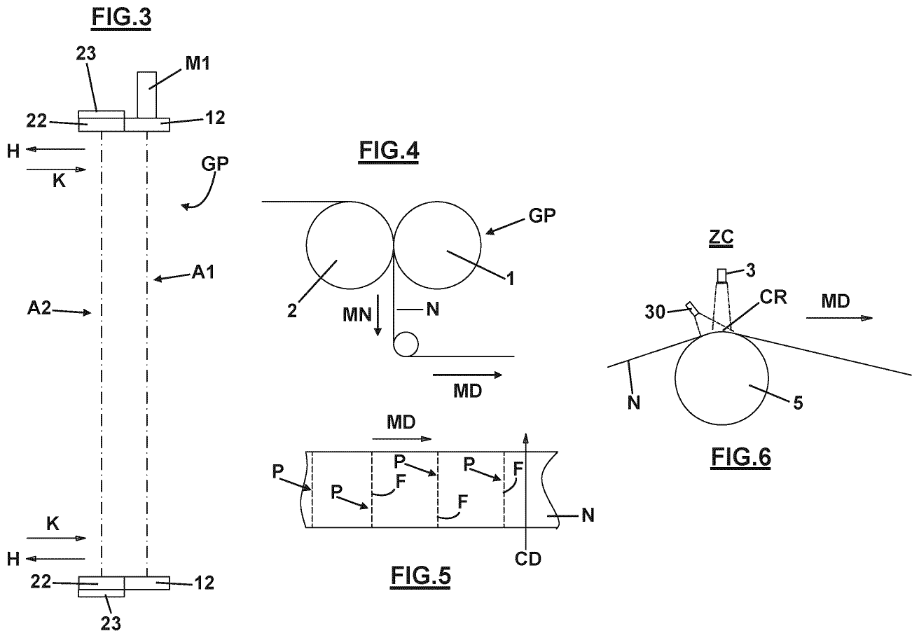

The reciprocal position of the rollers 1, 2 is adjustable. For example, the first roller 1 can be mounted with the respective pins 11 on corresponding fixed supports 12 and the second roller 2 can be mounted with the respective pins 21 on corresponding mobile supports 22 which allow the distance thereof from the first roller 1 to be adjusted. In FIG. 1 and FIG. 2 for simplification the supports 12, 22 are shown only on the side opposite to the motor M1. The supports 22 of the roller 2 are connected to respective actuators 23. For example, the actuators 23 can move the supports 22 so as to move the roller 2 parallel to itself to and from the roller 1, or they can move the supports 22 in a differentiated way so as to modify the axial orientation of the roller 2 with respect to the roller 1. In FIG. 3 the arrows H, K represent possible movements of the supports 22 controlled by the actuators 23. This structure is known per se.

The perforating unit GP produces perforation lines P transversely to the web material N which passes between the blades and the counter-blade in use. In other words, the perforation lines P are oriented along a predefined direction CD which is generally a direction orthogonal to a direction MN of transit of the web material N between the rollers 1, 2. In relation to the rotation speed of the first roller 1 and the advancement speed of the web material N, the perforation lines P are spaced apart from each other by a predetermined value. The perforation lines P are each formed by a predetermined number of incisions or perforations F oriented transversally to the web material N, the incisions F being spaced apart from each other by a predetermined value. The mechanisms for moving the web material N are per se known and therefore not described in detail. In general, the movement of the web-like material N is determined by the traction exerted on it by members purposely provided in the machines which use the material itself. For example, in a rewinder for paper converting the movement of the web material N is determined by the traction exerted on it by the winding rollers of the rewinder or also by the embossing rollers if the web material is subjected to embossing before being transformed into a log by means of the rewinder.

Advantageously, a control system in accordance with the present invention comprises an optical unit 3 adapted to optically detecting the perforations F in a predetermined control zone ZC of the path followed by the web material N downstream of the perforating unit GP while the web material N moves along said path. The optical unit 3 is configured to acquire images of the web material N in correspondence with the perforation lines P. For example, the optical unit 3 can be a camera. The optical unit 3 is connected to a programmable processing unit 4 which receives electrical signals produced by the optical unit 3 and processes them according to a programmed processing criterion which includes a comparison between the predetermined number of perforations F of at least one perforation line P and the number of perforations detected by the optical unit 3 on the same perforation line. Depending on the comparison made in this way, the processing unit 4 can emit an error signal which can be used to signal an anomaly condition relating to the operation of the perforating unit GP. For example, as further described below, said error signal is emitted if, on a perforation line P which should have twenty perforations F (NPP=preset number of perforations) the optical unit 3 detects only ten perforations (NPR=number of perforations detected). Or, for example, said error signal is emitted if on a perforation line P which should have twenty perforations F (NPP) the optical unit detects sixteen perforations (NPR) and the four missing perforations F are consecutive along the perforation line. More generally, in accordance with the present invention, the perforations F of each perforation line P and their positions are detected in order to count the missing perforations with respect to those that the perforation line P should have in conditions of correct operation of the perforating unit and to check if the missing perforations on the perforation line in question are consecutive or not. A possible criterion for signaling an incorrect operating condition of the perforating unit consists in emitting the error signal if NPR<=a*NPP where “a” is a control parameter which can assume a predetermined value, lower than one, in function of the quality level deemed acceptable for the finished product. For example, “a” can be a value comprised between 0.50 and 0.95. Again, a possible criterion for signaling a condition of incorrect operation of the perforating unit consists in emitting the error signal if the optical unit detects a number of missing consecutive perforations (NPC) (missing perforations in correspondence with adjacent positions along the examined perforation line) greater than a pre-established threshold value (NPS). To these criteria can be assigned priorities of different levels such that one of them can assume the role of primary control criterion and the other the role of secondary control criterion. For example, the criterion based on the count of the perforations could be the primary control criterion and the one based on the detection of the positions of the missing perforations could be the secondary control criterion, it being understood that these roles can be reversed. Also, the above-described control criteria could be combined, in the sense that the error signal could be emitted if both the conditions NPR<=a*NPP and NPC>=NPS are met.

An illuminator 30 is preferably associated with the optical unit 3. Said illuminator 30 can be arranged on the same side as the optical unit 3 with respect to the web-like material N or on the opposite side depending on the desired configuration, as further described below. Experimental tests conducted by the Applicant have shown that the optical unit 3 detects the perforations F more precisely if the web material N is spread out in the detection position. To this end, the optical unit 3 is preferably arranged at a point of the path followed by the web material N where the latter is guided on a guide roller 5 which determines its curvature (of radius equal to the radius of the guide roller 5) so that the localized traction of the web material following its passage on the guide roller 5 causes a slight extension of the perforations F and, therefore, a clearer contrast between the color of the web material N and the color of the underlying guide roller. More generally, the optical unit 3 is preferably arranged at a point of the path followed by the web-like material N where the latter passes over a convex surface with the convexity facing the optical unit 3. In this configuration, the illuminator 30 is placed on the same side as the optical unit 3 with respect to web-like material N. Such a configuration is represented by way of example in the diagram of FIG. 6.

In a possible alternative implementation mode of the present invention, the illuminator 30 is placed on the opposite side of the optical unit 3 with respect to the web material N.

In a further alternative embodiment of the present invention, the illuminator 30 can be placed inside the guide roller 5 or the convex surface described above which, in this case, are provided with openings or surfaces transparent to the light.

Preferably, said error signal is used to activate an automatic procedure for identifying one or more components (one or more blades 10A-10F or the counter-blade 20) of the perforating unit whose state may have caused the emission of the error signal. For example, one or more blades 10A-10F or the counter blade 20 may be broken or excessively worn. Or, for example, the reciprocal position of the blades 10A-10F and the counter blade 20 may be incorrect, in the sense that the distance between the blades 10A-10F and the counter blade 20 could be excessive.

Furthermore, preferably, said error signal is used to activate an automatic procedure for correcting the position of a component of the perforating unit, for example the position of the counter-blade in use. Examples of automatic correction procedures are described below.

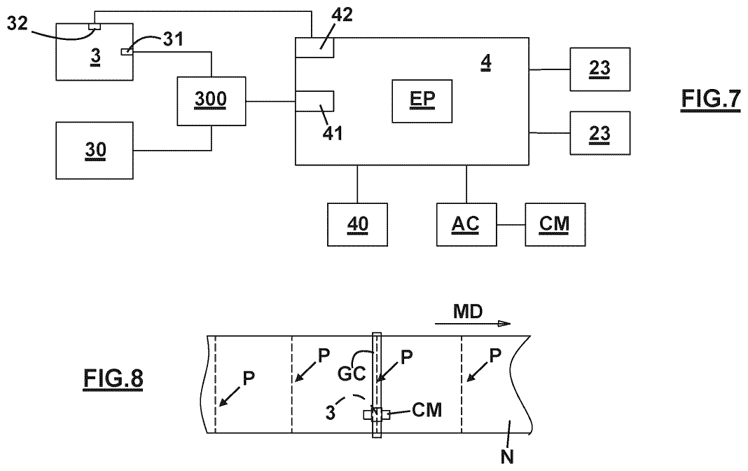

In accordance with a possible embodiment of the present invention, the processing unit 4 is connected, by means of an encoder 40 (shown only in the block diagram of FIG. 7) to the first roller 1. Therefore, the processing unit 4 acquires the position of the blades 10-10F, and therefore the position of the perforation lines P on the web material N, as the perforation lines are formed. The same processing unit 4 controls the activation of the optical unit 3 through the controller 300 of the unit 3 and, synchronously, of the illuminator 30, to perform the aforementioned detection of the perforation lines P at the point where the optical unit 30 is arranged. For this purpose, the processing unit 4 has an output 41 connected to an input of the controller 300 which, in this way, is driven by the processing unit 4. An output 32 of the optical unit 3 is connected to a respective input 42 of the processing unit 4 which, in this way, receives the images acquired by means of the optical unit 3. An output of the controller 300 is connected to an input 31 of the optical unit 3. In the diagram of FIG. 7 the controller 300 is connected to the output 41 of the processing unit 4 and the processing program is indicated by the reference EP. This program can be stored in an internal memory section of the processing unit 4 or also in an external unit connected to the processing unit 4.

Preferably, the illuminator 30 is a pulsed linear illuminator.

To carry out experimental tests, an Omron STC-MBS 163 POE matrix camera with an Omron FH2050 controller with a shutter speed of one microsecond positioned 30 cm distanced from the web material N (consisting of white tissue paper for the production of toilet paper rolls) was used. The illuminator 30 used for carrying out the experimental tests was a Genesi GEVX 34-6K-UD-200-M12S illuminator. At the point of acquisition of the images the web-like material N passed over a black supporting roller.

By carrying out the aforementioned optical detection at a point of the path followed by the web-like material N where the latter is stretched (for example, as previously described, at a point where the web- like material follows the profile of a convex surface) it is possible to completely open the aperture of the camera such that more light can enter the camera despite the short exposure time. Furthermore, the stretching of the web material causes greater visibility of the underlying surface and, therefore, greater visibility of the perforations F.

It goes without saying that the use of a surface of a different color than the web-like material N placed behind the material itself favors a more correct optical detection of the perforations F on each perforation line P.

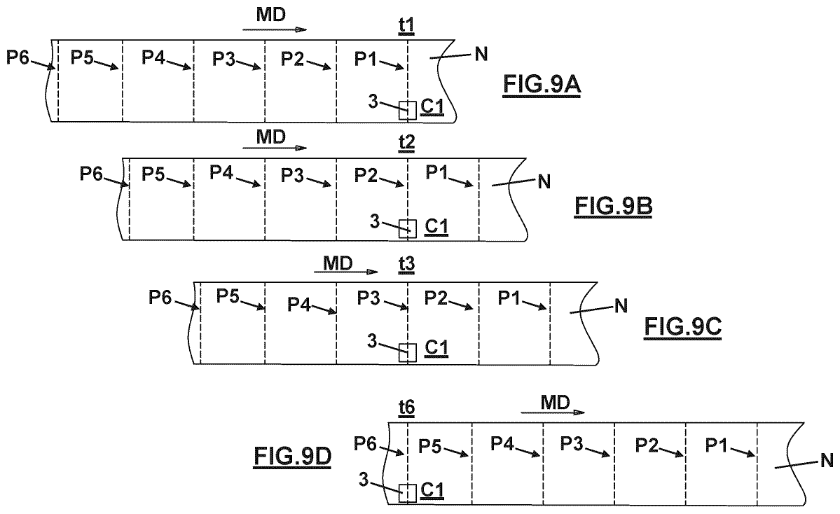

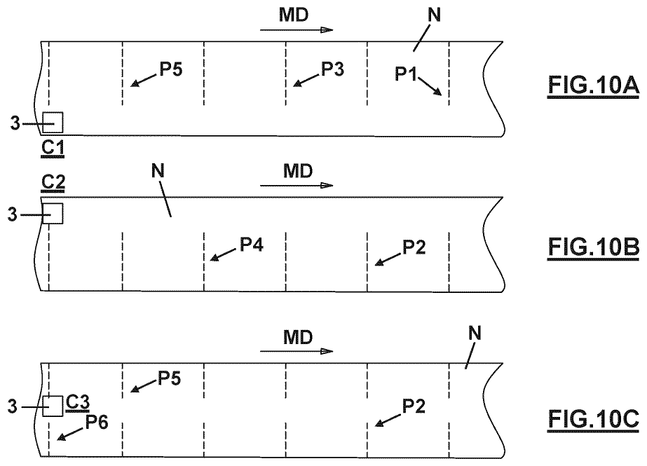

A particularly advantageous solution from an economic point of view consists in providing an optical unit capable of framing a part (for example a third) of the width of the web material, i.e. a part (for example a third) of each perforation line P and mounting the optical unit on a carriage CM which can be moved orthogonally to the direction MD followed by the web-like material N in the control region ZC. The carriage CM can be mounted on a respective guide GC oriented orthogonally to said direction MD in the control region ZC. The carriage CM can be operated by a respective actuator AC controlled by the processing unit 4 which is suitably connected to this actuator. With reference to the diagrams of FIGS. 10A-10C, the carriage CM positions the optical unit 3 in the control positions C1, C2 and C3, i.e. in correspondence with the lateral parts C1, C2 and the central part C3 of the path followed by the web-like material N. In this way, the optical unit 3 can frame the lateral parts and the central part of each perforation line. In the diagrams of FIGS. 9A-9D the perforation lines are indicated by the references P1, P2, P3, P4, P5, P6 assuming that 6 blades 10A-10F are mounted on the blade-holder roller 1 so that each perforation line P1-P6 is produced by the interaction of a respective blade 10A-10F with the counter blade 20. It is understood, however, that said control positions may be in a different number (for example, in number of two or four or five) according to of the width of the web material and of the shooting field CR of the optical unit 3. In a possible control cycle in accordance with the present invention, initially the carriage CM is positioned at the control point C1 and in six different instants t1-t6 the optical unit 3, driven by processing unit 4, acquires the image of a corresponding lateral portion of each perforation line P1-P6 while the web material N moves along the direction MD. This process can possibly be repeated for a predefined number of times (for example ten times) to reduce the risk of an error signal being emitted not due to the absence of perforations but due, for example, to the temporary presence of dust at the point of control C1. If the images acquired by the optical unit at the lateral control point C1 reveal the constant absence of all perforations on all perforation lines P1-P6 then the processing unit 4 emits an error signal which can be used to activate an alerting procedure for the operators assigned to the machinery and/or an automatic corrective procedure consisting in adjusting the skew of roller 2 or moving roller 2 parallel to itself towards roller 1, acting on the respective mobile support 22 to restore correct operation of the perforating unit. If, despite the corrective procedure activated, the error persists, then, assuming that the counter-blade is broken or excessively worn, the operators will stop the machinery to intervene manually on the perforating unit. If, on the other hand, no error signals are emitted by the processing unit 4, then the carriage CM is moved to the other side control point C2 and the previously described procedure is repeated. Finally, the carriage CM is moved to the central control point C3 and the previously described procedure is repeated. In each of the aforementioned procedures an error signal may be emitted by the processing unit 4 even if, for example, at said control points the optical unit 3 detects the absence of a predetermined part of perforations on the perforation lines P1-P6.

In this way the quality control of the perforations is divided on bands of the web material of pre-established transversal width.

In the exemplary diagrams of FIG. 10A, FIG. 10B and FIG. 10C the perforation lines show absence of perforations on the right lateral band (FIG. 10A), on the left lateral band (FIG. 10B) and on the central band (FIG. 10C) of the web material N.

Preferably, the optical unit 3 first acquires the images of the perforation lines at the lateral control points C1, C2 and then the images of the perforation lines at the central control point C3. This is because experience has shown that the loss of perforations occurs more frequently on the side bands of the web material.

However, it is possible to make use an optical unit 3 whose shooting range extends to the entire control area ZC even if such a solution may be more expensive since the optical unit 3 in this case must be equipped with optical and electronic components more expensive because they are capable of providing sharp images of a larger area.

If the defect detected by the optical unit 3 always concerns the same perforation line (for example the perforation line P4), then the error signal can be used to control an automatic adjustment of the perforating unit, for example by moving the support 22 to bring roller 2 closer to roller 1. If the error persists, it can be assumed that the corresponding blade 10D is broken and in this case it can be replaced.

It is understood that the specific procedures for emitting the error signal and/or the specific automatic corrective procedures activated by the emission of the error signal may be different from those described above by way of example. In general, in fact, both the total number of missing perforations on the same perforation line and the number of consecutive missing perforations on the same perforation line can be predefined, depending on the pre-established quality for the finished product.

For example, the web material N can be a paper web formed by one or more superimposed plies, or a film of plastic or bio-plastic material or a non-woven fabric.

From the foregoing description it is evident that a perforating unit in accordance with the present invention comprises at least one blade 10A-10F and a counter-blade 20 configured to form perforation lines P on web-like materials N running along a predefined path, in which the perforation lines are each formed by a predetermined number of perforations F spaced apart from each other by a predetermined value and aligned along a predetermined perforation direction CD, and comprises an optical unit 3 adapted for optically detecting the perforations F of each perforation line P in a zone of control ZC arranged along said path downstream of the perforating unit GP while the web material N moves along this path, the optical unit 3 being configured to acquire images of the web material N in correspondence with the perforation lines P, the optical unit 3 being connected to a programmable processing unit 4 which receives electrical signals produced by the optical unit 3 and processes them according to a programmed processing criterion which includes a comparison between the predetermined number of perforations F of the perforation lines P and the number of perforations detected by the optical unit 3 on each perforation line, and, depending on the comparison thus made, the processing unit 4 is able to emit an error signal indicative of an anomaly condition relating to the operation of the perforator unit GP.

Therefore, in accordance with the present invention, a comparison is performed based on the detection of the number of perforations of each perforation line using an optical unit 3, that detects the perforations of each perforation line, and a processing unit that performs said comparison.

In practice, the execution details can in any case vary in an equivalent way as regards the individual elements described and illustrated without thereby abandoning the idea of the solution adopted and therefore remaining within the limits of the protection granted by the present patent in accordance with the following claims.

1.-10. (canceled)

11. A perforating unit comprising:
at least one blade and a counter-blade configured to form perforation lines on web materials running along a predefined path, in which the perforation lines are formed each by a predetermined number of perforations spaced apart by a predetermined value and aligned along a predetermined perforation direction, and
control area arranged along said path downstream of the perforating unit while the web material moves along the path, in that the optical unit is configured to acquire images of the web material in correspondence of the perforation lines, in that the optical unit is connected to a programmable processing unit which receives electrical signals produced by the optical unit and processes them according to a programmed processing criterion that comprises a comparison between the predetermined number of perforations of the perforation lines and the number of perforations detected by the optical unit on each perforation line, and in that, in function of the comparison made, the processing unit is configured to emit an error signal indicating an anomaly condition relating to the operation of the perforating unit.

12. The perforating unit according to claim 11, wherein the processing unit is programmed to emit the error signal if the total number of perforations detected by the optical unit on one or more perforation lines in the control zone is less than a predetermined percentage of the predetermined number of perforations.

13. The perforating unit according to claim 11, wherein the processing unit is programmed to emit the error signal if a number of consecutive perforations detected by the optical unit on one or more lines perforation in the control zone is less than a predetermined value.

14. The perforating unit according to claim 11, wherein said control zone is divided into a plurality of control sub-zones aligned transversely with respect to a direction of movement of the web material in the control area, and in that the optical unit is moved cyclically between the control subzones by a respective handling unit.

15. The perforating unit according to claim 4, wherein said control sub-zones comprise two lateral control sub-zones and in that the handling unit positions the optical unit first in correspondence with the lateral control sub-zones and subsequently in correspondence with any further control sub-zones comprised between the lateral control sub-zones.

16. The perforating unit according to claim 11, wherein the processing unit controls the activation of the optical unit.

17. The perforating unit according to claim 11, wherein said path comprises a convex surface where the control zone is arranged.

18. The perforating unit according to claim 11, wherein the at least one blade and the counter-blade are mounted on respective supports whose mutual position is adjustable, and that said error signal controls the mutual positioning of said supports.

19. The perforating unit according to claim 11, wherein an illuminator activated by the processing unit is associated with the optical unit.

20. The perforating unit according to claim 11, wherein the processing unit is programmed to emit said error signal if the anomaly condition detected by the optical unit occurs a preset number of times.
